(19) United States
(12) Patent Application Publication
(10) Pub. No.: US 2012/0140288 A1
(43) Pub. Date: Jun. 7, 2012

(54) PRINTING APPARATUS, PRINTING METHOD, AND STORAGE MEDIUM

(75) Inventor: Taro Tsuchida, Kawasaki-shi (JP)

(73) Assignee: CANON KABUSHIKI KAISHA, Tokyo (JP)

(21) Appl. No.: 13/308,381

(22) Filed: Nov. 30, 2011

(30) Foreign Application Priority Data
Dec. 6, 2010 (JP) 2010-271737

(51) Int. Cl. G06K 15/02

(52) U.S. Cl. 358/1.16

(57) ABSTRACT

A printing apparatus includes an interface unit configured to connect a portable memory storing print data including a print ticket, and a processing unit configured to set print setting information, wherein the processing unit is further configured to print, if the print ticket is prioritized when printing the print data, the print data based on print setting information included in the print ticket, and if the print ticket is not prioritized when printing the print data, to add the print setting information to the print data and to print the print data based on the print setting information.

### BACKGROUND OF THE INVENTION

1. Field of the Invention

The present invention relates to a printing apparatus, a printing method, and a storage medium.

2. Description of the Related Art

Conventionally, if electronic data such as document data and image data is to be printed via an information processing apparatus, e.g., a personal computer, the information processing apparatus generates print data using a printer driver. In such a case, print setting information described in a page description language is added to the print data. The information processing apparatus then inputs the print data to a printing apparatus, using a network protocol such as the Line Printer Daemon protocol (LPR). The printing apparatus performs printing by determining a paper size, a paper type, whether to perform one-sided printing or two-sided printing, and a stapling position according to the print setting information added to the print data.

In recent years, there is a widespread use of printing apparatuses (i.e., single function peripheral (SFP) or multifunction peripheral (MFP)) having a direct print function. The direct print function allows document data (e.g., a Portable Document Format (PDF) file or an Extensible Markup Language (XML) Paper Specification (XPS) file) stored in a universal serial bus (USB) flash memory to be directly printed. In such a case, the document format such as XPS is a document format to be referred to by a personal computer or an information terminal, in addition to being the document data. As a result, print setting information, to be used in a printing apparatus assumed to print the print data when the print data has been created, may be passed onto and be viewed by another user while being included in the print data. Further, if another user (i.e., a printing user) directly prints the print data using the direct print function, the print data including the print setting information for the initially assumed printing apparatus may be input to a different printing apparatus. The printing user may then receive an undesired print result.

There are methods for solving such mismatch in the print setting information. For example, Japanese Patent Application Laid-Open No. 2003-223298 discusses a method in which the print setting information is separately managed, and the print setting information of the print data is changed to match each printing apparatus. As a result, there is no mismatch with respect to the printing apparatus. Further, Japanese Patent Application Laid-Open No. 2010-92487 discusses a method for changing, if there is a mismatch in the print setting information of the print data, the print setting information and manually or automatically correcting the mismatch.

If printing is performed using the conventional printer driver, the print setting is specified, when issuing a print instruction, to match the printing apparatus to which printing is instructed. A mismatch between the print setting information and the function of the printing apparatus thus does not occur. However, if the direct print function is used so that the print data including the print setting information is transported and printed, a mismatch may occur between the print setting information and the function of the printing apparatus when printing is performed.

Further, the print setting information originally included in the print data may not become effective in the method discussed in Japanese Patent Application Laid-Open No. 2003-223298 in which the print setting information is separately managed and changed to match each printing apparatus. Furthermore, the method discussed in Japanese Patent Application Laid-Open No. 2010-92487, which manually or automatically corrects the mismatch in the print setting information, does not correct the mismatch between the print setting information and the function of the printing apparatus.

### SUMMARY OF THE INVENTION

The present invention is directed to a printing apparatus capable of appropriately performing printing using the direct print function.

According to an aspect of the present invention, a printing apparatus includes an interface unit configured to connect a portable memory storing print data including a print ticket, a processing unit configured to set print setting information, wherein the processing unit is further configured to print, if the print ticket is prioritized when printing the print data, the print data based on print setting information included in the print ticket, and if the print ticket is not prioritized when printing the print data, add the print setting information to the print data and print the print data based on the print setting information.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of an XPS file.

FIG. 2 illustrates a configuration example of a printing system.

FIG. 3 illustrates an example of a hardware configuration of a printing apparatus.

FIG. 4 illustrates configuration examples of a random access memory (RAM) and a read-only memory (ROM).

FIGS. 5A and 5B illustrate configuration examples of the print ticket.

FIG. 6 is an example of a flowchart illustrating a process performed according to a print data processing program.

FIG. 7 is an example of a flowchart illustrating a process performed according to a print setting program.

FIG. 8 is an example of a flowchart illustrating a process performed according to a printing program.

FIGS. 9A, 9B, 9C, and 9D illustrate examples of print data processing.

FIGS. 10A, 10B, 10C, and 10D illustrate examples of a screen used for instructing printing of print data.

FIG. 11 is an example of a flowchart illustrating a process performed according to a user interface (UI) setting program.

FIGS. 12A and 12B illustrate examples of the print ticket.

FIG. 13 is an example of a flowchart illustrating a process performed according to a transmission program.

### DESCRIPTION OF THE EMBODIMENTS

Various exemplary embodiments, features, and aspects of the invention will be described in detail below with reference to the drawings.

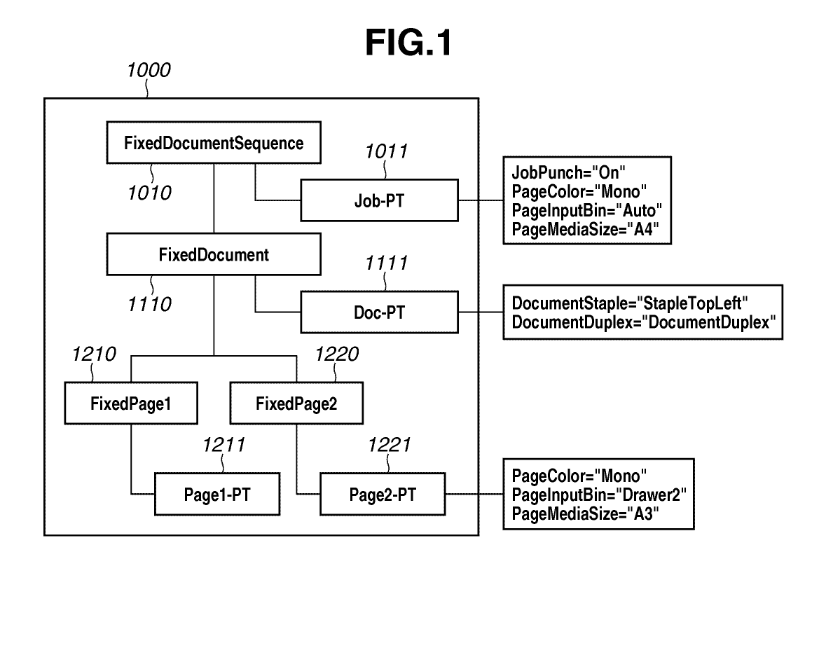

The XPS file, which is an example of a file (document) that can be employed according to an exemplary embodiment of the present invention, will be described below. FIG. 1 illustrates an example of the XPS file (i.e., an XPS file 1000). XPS is one of electronic document formats. Referring to FIG. 1, the XPS file 1000 includes three layers, i.e., FixedDocumentSequence 1010, FixedDocument 1110, and FixedPage (including FixedPage1 1210 and FixedPage2 1220). Print setting files referred to as a print ticket (PT) (i.e., Job-PT 1011, Doc-PT 1111, Page1-PT 1211, and Page2-PT 1221) can be associated with each layer respectively.

The print ticket is defined by the Print Schema Specification, which is a specification that describes the functions and configuration of the printing apparatus related to a print job. Further, the print ticket is described in XML similarly as XPS, and keywords and parameters unique to a vendor can be added thereto. If the setting information described in a plurality of print tickets overlaps, the setting information of the lower layer is prioritized. In other words, the order of priority becomes Page-PT (1211 and 1221)>Doc-PT 1111>Job-PT 1011.

There are two aspects of the XPS file 1000, i.e., as a spool format used in printing, and as a normal document. As a document, the XPS file 1000 can be used as a document format for various documents to be published and distributed, similar to a PDF file developed by Adobe Systems Inc. On the other hand, as a spool format, the XPS file 1000 can store a print ticket used to designate the print setting for each node of the layer as described above. According to the present exemplary embodiment, the print setting information is added to a print ticket of an XPS file, so that the content of the XPS file is printed as intended by the printing user. The configuration of the present exemplary embodiment will be described in detail below.

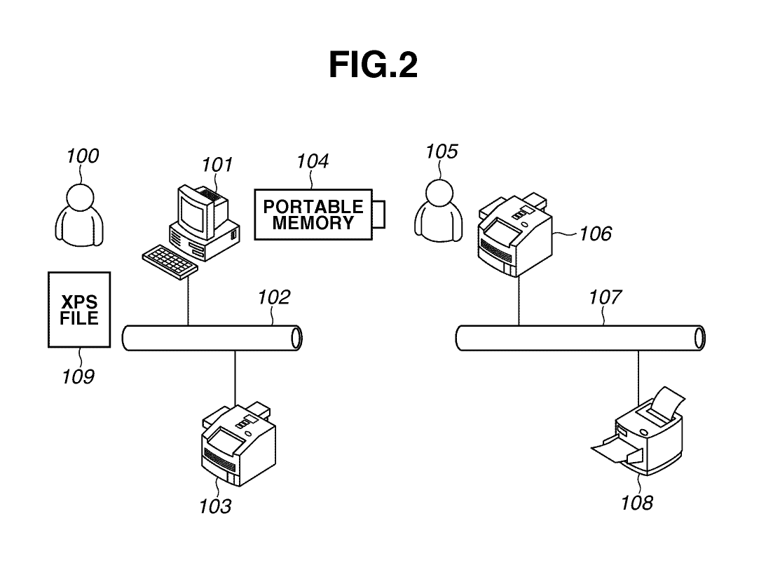

FIG. 2 illustrates a configuration example of the printing system according to the present exemplary embodiment. Referring to FIG. 2, the printing system includes a personal computer (PC) 101 and a printing apparatus 103. The PC 101 and the printing apparatus 103 are connected to be able to communicate with each other via a network 102. The PC 101 is an example of an information processing apparatus (i.e., a computer), and the printing apparatus 103 is an example of an image forming apparatus (i.e., a multi-function peripheral) including a print function, a copy function, a facsimile function, and a scanner function.

A data creator 100 of the printing system prints using the printing apparatus 103 via the PC 101 and the network 102. For example, the data creator 100 creates print data 109 using the PC 101. The print data 109, which is the print data created by the data creator 100, is an XPS format file.

Further, the printing system includes printing apparatuses 106 and 108 connected to be able to communicate with each other via a network 107.

For example, a printing user 105 prints the print data 109 stored in a portable memory 104 using the printing apparatus 106. The portable memory 104, e.g., a USB flash memory, stores the print data 109. Further, the printing user 105 uses a data transfer function in the printing apparatus 106 and transmits the print data to the printing apparatus 108 via the network 107.

According to the present exemplary embodiment, the printing apparatus 103 includes a two-sided printing function and a staple function, and the printing apparatus 106 includes only the two-sided printing function. Further, the printing system is not limited to the above-described configuration and may be changed as appropriate.

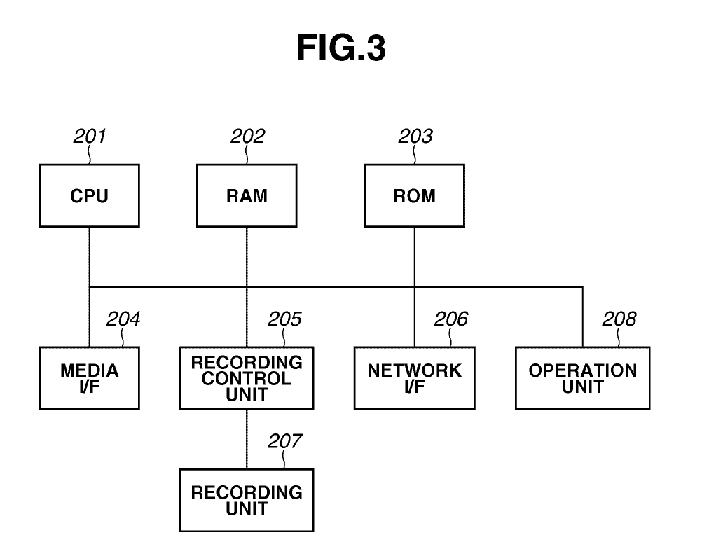

FIG. 3 illustrates an example of the hardware configuration of the printing apparatus (i.e., the printing apparatuses 103, 106, and 108). Referring to FIG. 3, a central processing unit (CPU) 201 controls each unit in the printing apparatus. A RAM 202, which includes a work area for loading a program used by the CPU 201 and a non-volatile area, stores the print setting information and information of various parameters. A ROM 203 stores various programs by which the CPU 201 controls each unit. A media I/F 204 connected to the portable memory 104, which is an example of a storage medium, reads and writes the print data in the portable memory 104 according to an instruction from the CPU 201.

A recording control unit 205 controls a recording unit 207, and sets various information to the recording unit 207 according to an instruction from the CPU 201. A network I/F 206 connects to the network (i.e., the network 102 and the network 107), and receives the print data via the network or transmits the print data in the portable memory 104 to the outside according to an instruction from the CPU 201. The recording unit 207 records on a recording medium the print data according to the various types of information set by the recording control unit 205. An operation unit 208 displays various types of information and receives an input from the user. For example, the operation unit 208 selects and instructs printing of the print data in the portable memory 104 in responds to the operation thereon (i.e., a user operation), based on control performed by the CPU 201.

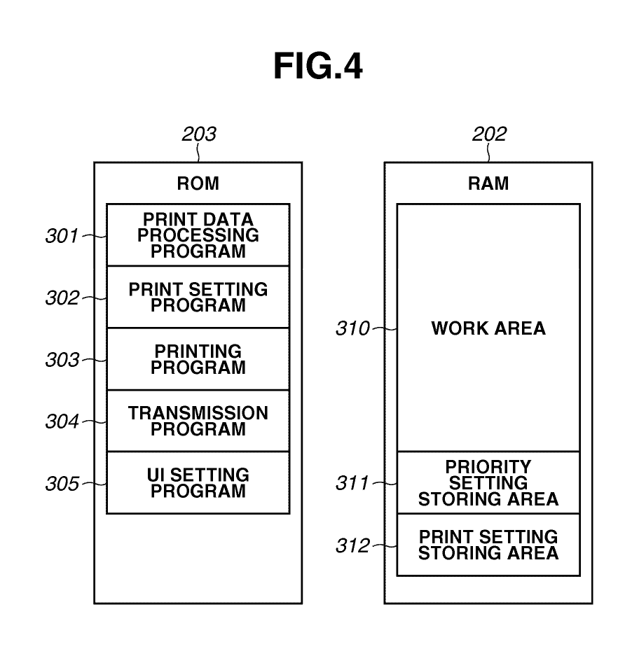

FIG. 4 illustrates configuration examples of the RAM 202 and the ROM 203 in the printing apparatus illustrated in FIG. 3. Referring to FIG. 4, the RAM 202 includes a work area 310, a priority setting storing area 311, and a print setting storing area 312. The ROM 203 includes an area for storing various programs. For example, the ROM 203 stores a print data processing program 301, a print setting program 302, a printing program 303, a transmission program 304, and a UI setting program 305.

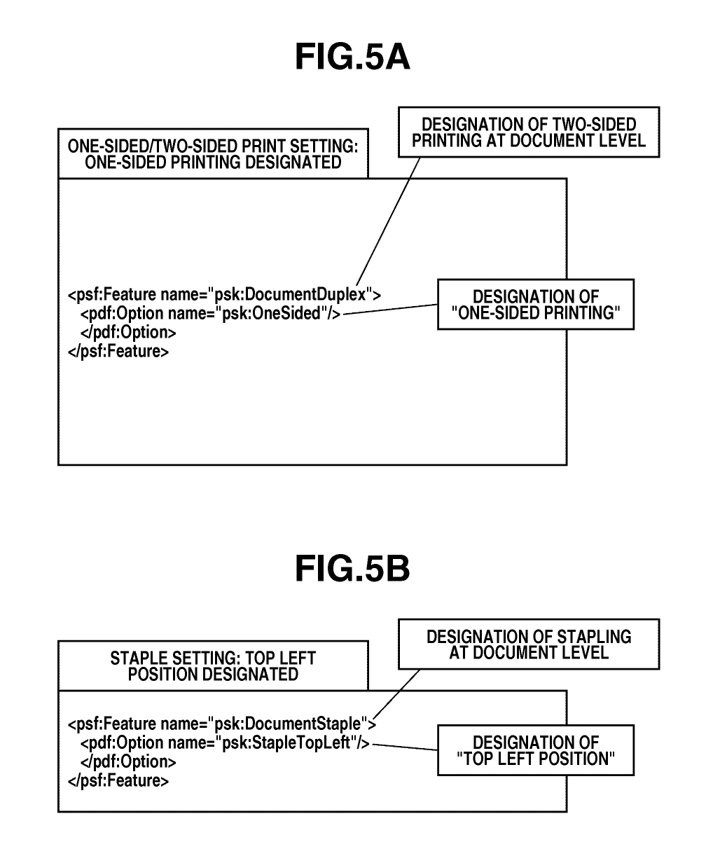

The print data will be described below with reference to FIGS. 5A and 5B. FIGS. 5A and 5B illustrate configuration examples of the print ticket (i.e., a portion of the print data). The print data is generated using a print data generation driver, based on an instruction from application software, such as Office document or Image Viewer, installed in the PC 101 operated by the data creator 100. For example, a plug-in released from Microsoft® Co. for generating the XPS format file for an Office application can be installed on the PC 101 to generate the Office document as an XPS file.

In other words, the data creator 100 creates the XPS file, i.e., the print data, from the document data using the above-described applications. In such a case, the data creator 100 sets a desired print setting content (i.e., setting values) to the print data, in view of the printing functions in the printing apparatus 103. As described above, according to the present exemplary embodiment, the printing apparatus 103 includes the staple function and the two-sided printing function. A case where the data creator 100 has specified the following settings with respect to the print data 109 will be described below.

(1) Staple top left position
(2) Two-sided printing: Perform one-sided printing

FIG. 5A illustrates an example in which the print setting information for the two-sided print setting function is described in the print ticket of the print data 109. Further, FIG. 5B illustrates an example in which the print setting information for the staple function is described in the print ticket of the print data 109.

<Case 1: Printing of the Print Data>

A process in which the printing apparatus 103 prints the print data 109 (i.e., print data including the print setting information) created by the data creator 100 based on the print function of the printing apparatus 103 will be described below (i.e., case 1). More specifically, an operation of the printing apparatus in a case where there is no mismatch between the print setting information, set to the print data received by the printing apparatus via the network, and the printing functions of the printing apparatus, will be described below.

The printing process performed by the printing apparatus 103 starts when the printing apparatus 103 receives the print data 109 transmitted from the PC 101 via the network 102 using a protocol such as LPR, in response to an operation by the data creator 100 on an input device. Transmission and reception of the print data via the network 102 are common processes, so that the detailed description will be omitted.

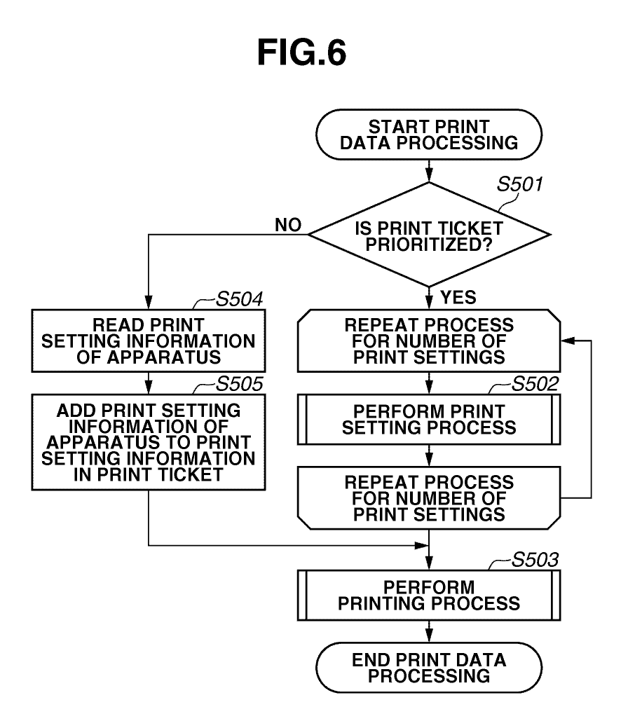

The process performed by the printing apparatus 103 from receiving the print data 109 to printing the print data 109 will be described below with reference to FIGS. 6, 7, and 8. The functions in the printing apparatus 103 and the processes according to the flowcharts to be described below are realized by the CPU 201 in the printing apparatus 103 performing the processes according to the procedures in the programs stored in the ROM 203.

FIG. 6 is an example of a flowchart illustrating a process performed according to the print data processing program 301. A print data processing unit is realized by the CPU 201 in the printing apparatus 103 executing the print data processing program 301.

In step S501, the print data processing unit determines whether processing is to be performed while prioritizing the print ticket. If the print data processing unit determines to perform processing while prioritizing the print ticket (YES in step S501), the process proceeds to step S502. If the print data processing unit does not determine to perform processing while prioritizing the print ticket (NO in step S501), the process proceeds to step S504.

The printing user who instructs printing on the printing apparatus designates whether to prioritize the print ticket as will be described below. However, if the printing apparatus receives the print data via the network, it is determined that processing is performed while prioritizing the print ticket. According to case 1, the printing apparatus 103 receives the print data via the network 102, so that it is determined that processing is performed while prioritizing the print ticket. The process thus proceeds to step S502.

In step S502, the print setting process is performed. The print setting process will be described in detail below. In the print setting process, the print setting information is read from the print ticket, and if there is print setting information corresponding to the printing apparatus 103, the print setting information becomes effective. According to the present exemplary embodiment, the print data processing unit repeats the print setting process by the number of pieces of print setting information in the print ticket (i.e., the number of settings). If the processes with respect to all of the print setting information in the print ticket have been completed, the process proceeds to step S503 (i.e., printing process). The printing process will be described below.

In step S504, the print data processing unit reads from the RAM 202 the print setting information of the printing apparatus 103 set via the UI setting unit to be described below. In step S505, the print data processing unit adds, to the print setting information in the print ticket, the read print setting information of the printing apparatus 103 (i.e., adds additional information to the print ticket). The process then proceeds to step S503.

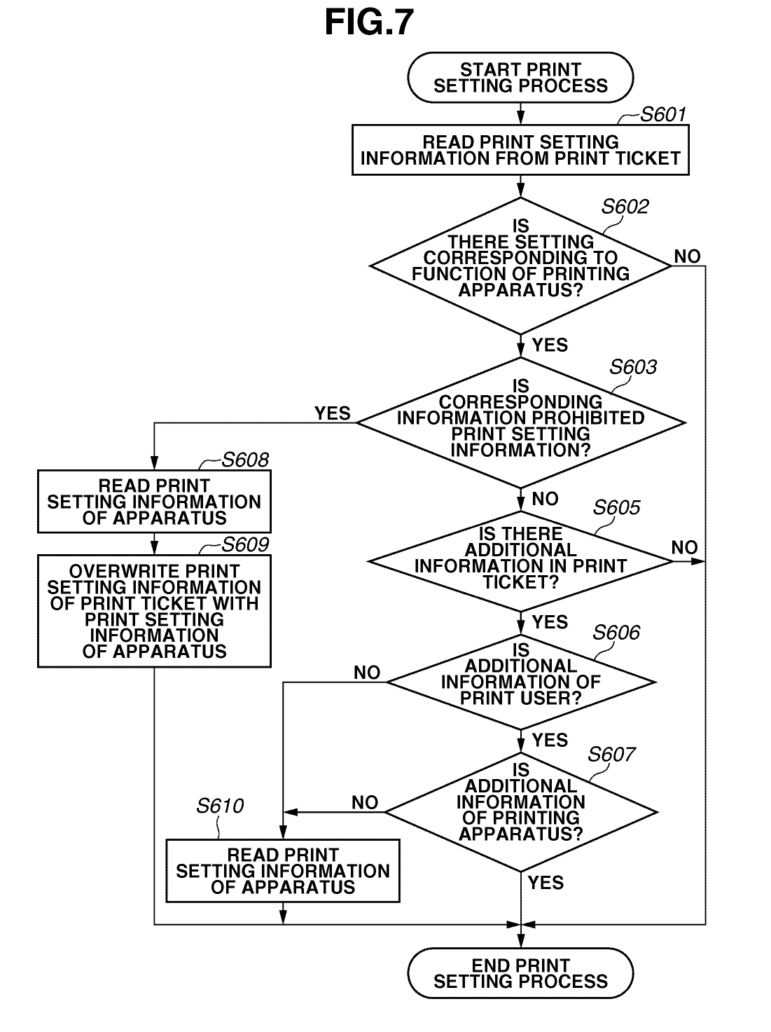

The print setting process will be described below with reference to FIG. 7. FIG. 7 is an example of the flowchart illustrating a process performed according to the print setting program 302. A print setting unit is realized by the CPU 201 in the printing apparatus 103 executing the print setting program 302. In step S601, the print setting unit reads the print setting information from the print ticket. In step S602, the print setting unit determines whether the read print setting information is information that corresponds to the function of the printing apparatus 103.

If the print setting unit determines that the read print setting information is not information corresponding to the function of the printing apparatus 103 (NO in step S602), the print setting process ends. On the other hand, if the print setting unit determines that the read print setting information is information corresponding to the function of the printing apparatus 103 (YES in step S602), the process proceeds to step S603. In step S603, the print setting unit determines whether the read print setting information is the print setting information that is prohibited in the printing apparatus 103 (e.g., unauthorized setting information).

The print setting information prohibited in the printing apparatus 103 is previously set to the printing apparatus 103. For example, if color printing is prohibited in the operation of the printing apparatus 103, the print setting information to be used in performing the color print function is the print setting information prohibited in the printing apparatus 103.

If the print setting unit determines that there is prohibited print setting information (YES in step S603), the process proceeds to step S608. In step S608, the print setting unit reads from the RAM 202 the print setting information of the printing apparatus 103. In step S609, the print setting unit then changes the print setting information. The process for changing the print setting information is performed on the print setting information determined to be unusable if it remains stored as the print setting information. According to the present exemplary embodiment, the print setting unit overwrites the print setting information in the print data with the print setting information previously set to the printing apparatus 103, read in step S608.

According to case 1, the print setting information corresponding to the function of the printing apparatus 103 is set when the data creator 100 performs printing via the printing apparatus 103. The print setting unit thus determines that the read print setting information is not the prohibited print setting information (NO in step S603), and the process proceeds to step S605.

In step S605, the print setting unit determines whether there is additional information to the print ticket. If the print setting unit determines that there is additional information to the print ticket (YES in step S605), the process proceeds to step S606. If the print setting unit determines that there is no additional information to the print ticket (NO in step S605), the print setting process once ends.

According to case 1, the additional information is not yet added to the print ticket. The print setting unit thus determines that there is no additional information to the print ticket. The print setting unit then stores in the print setting storing area 312 in the RAM 202 the print setting information to be processed, and the print setting process ends. If the print setting unit determines that there is additional information to the print ticket, the process proceeds to step S606 and step S607 in which the print setting unit performs processes with respect to the additional information. The details of such processes will be described below.

Upon the print setting unit performing the print setting process for all of the print setting information, the printing process of step S503 illustrated in FIG. 6 is performed.

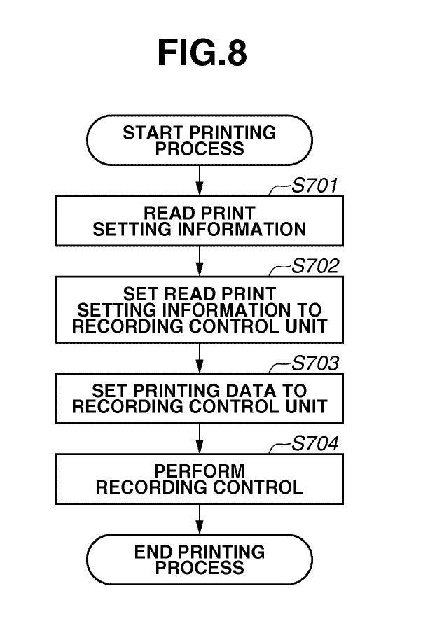

The printing process will be described below with reference to FIG. 8. FIG. 8 is an example of a flowchart illustrating a process performed according to the printing program 303. A printing unit is realized by the CPU 201 in the printing apparatus 103 executing the printing program 303.

In step S701, the printing unit reads the print setting information from the print setting storing area 312 storing the print setting information processed by the print setting unit. In step S702, the printing unit sets the read print setting information to the recording control unit 205.

In step S703, the printing unit sets to the recording control unit 205 printing data generated from a drawing data portion included in the print data 109. The printing data is generated by generating the drawing data using the page description language, and since it is a common process, the detailed description will be omitted. In step S704, the printing unit instructs recording to be started via the recording control unit 205, and the recording unit 207 thus performs printing.

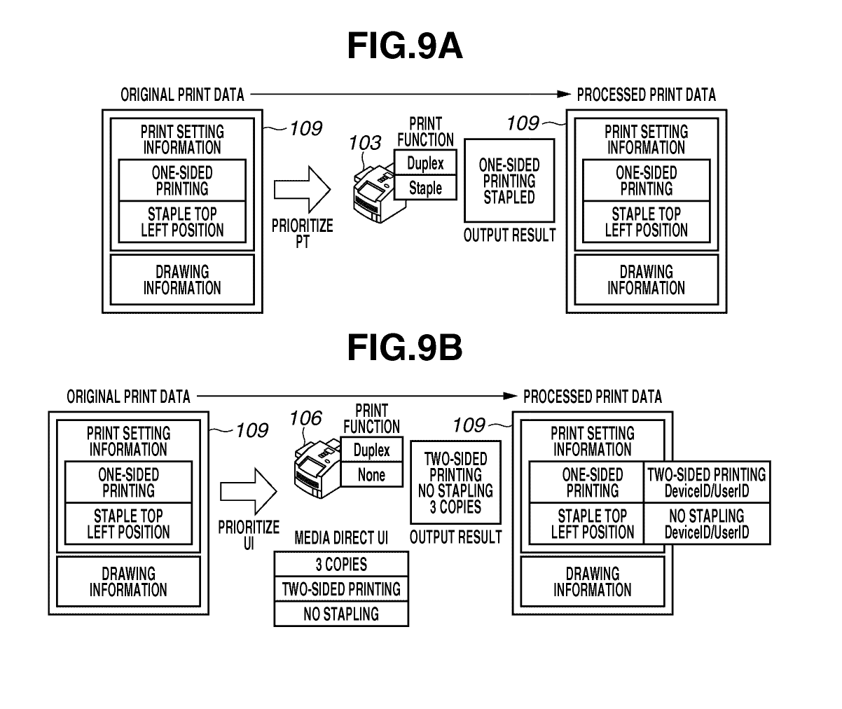

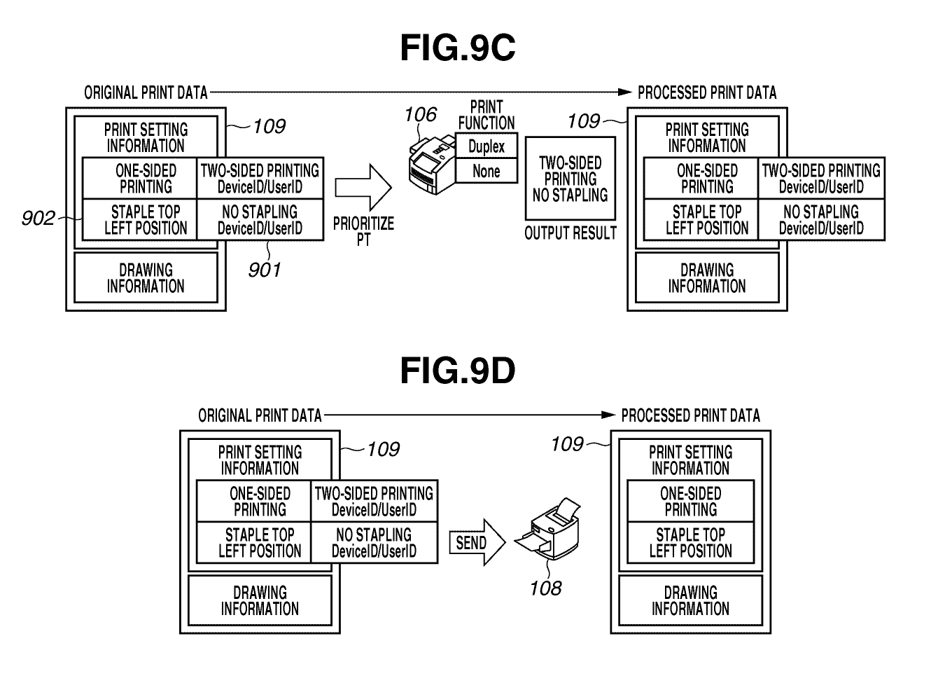

FIG. 9A illustrates an example of the process performed on the print data according to case 1. The print data 109 is processed while prioritizing the print ticket (PT), so that the output result as designated in the print setting information of the print data can be acquired. FIGS. 9B, 9C, and 9D illustrate examples of the processes performed on the print data according to cases 2, 3, and 4, respectively, to be described below.

<Case 2: Printing Using Direct Print Function>

Case 2 describes the operation of the printing apparatus 106 when there is a mismatch between the print setting information of the print data 109 and the functions of the printing apparatus 106 which is instructed to perform printing. The functions in the printing apparatus 106 and the processes according to the flowcharts to be described below are realized by the CPU 201 in the printing apparatus 106 performing the processes according to the procedures in the programs stored in the ROM 203.

The operation performed by the printing apparatus 106 when the print data 109 created by the data creator 100 is stored in the portable memory 104 and the printing user 105 instructs printing of the print data in the portable memory 104 will be described below. Since the portable memory 104 stores the print data, the printing user 105 instructs printing using the direct print function. More specifically, the printing user 105 connects the portable memory 104 to the printing apparatus 106, and selects via the operation unit 208 of the printing apparatus 106 the print data 109 stored in the portable memory 104. The printing user 105 then designates the print setting content and instructs printing, i.e., uses the direct print function.

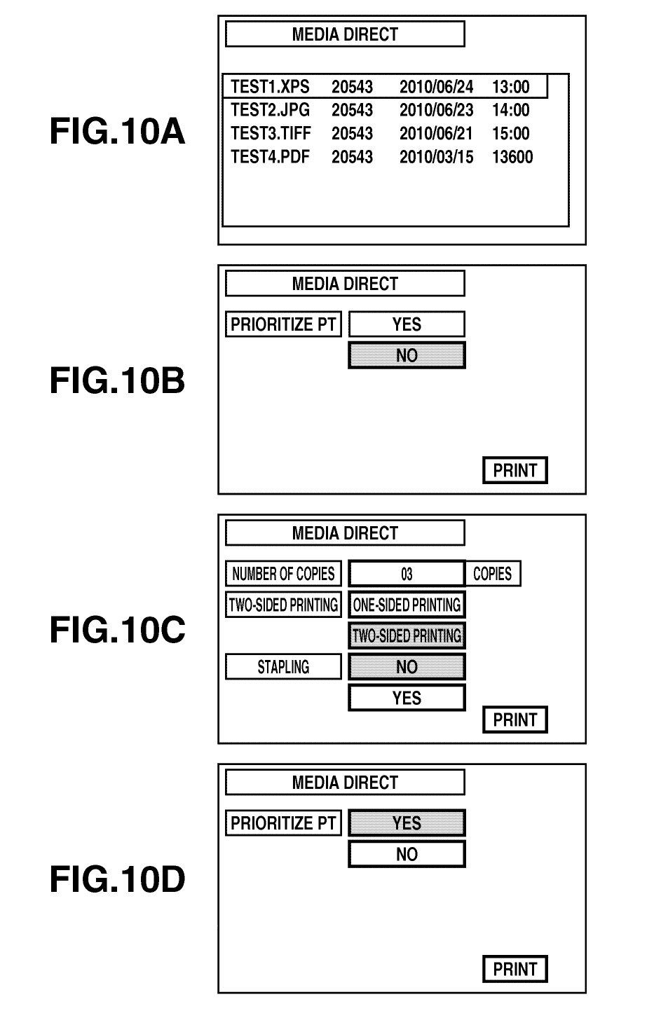

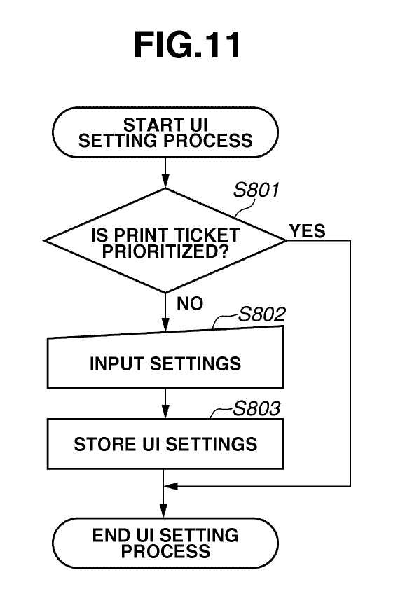

The printing process using the direct print function will be described below with reference to FIGS. 10A, 10B, 10C, 10D, and 11. FIGS. 10A, 10B, 10C, and 10D illustrate examples of the screen, i.e., media direct screen used for instructing printing of the print data stored in the portable memory 104, which is an example of the storing medium (media). The UI setting unit is realized by the CPU 201 in the printing apparatus 106 executing the UI setting program 305.

When the portable memory 104 is connected to the media I/F 204, the CPU 201 detects the portable memory 104 and activates the UI setting unit. The screen for designating the print data i.e., a print data designation screen, as illustrated in FIG. 10A is then displayed on the operation unit 208. The printing user 105 thus designates via the print data designation screen the desired print data.

If the printing user 105 selects the print data, a screen for selecting whether to prioritize PT, i.e., a selection screen, as illustrated in FIG. 10B is displayed on the operation screen 208. According to case 2, an example in which the printing user 105 selects not to prioritize PT and presses the print button will be described below. The subsequent process will be described by referring to FIG. 11 as appropriate.

FIG. 11 is an example of a flowchart illustrating a process performed according to the UI setting program 306. In step S801, the UI setting unit determines whether PT is prioritized. If the UI setting unit determines that PT is prioritized (YES in step S801), the UI setting process ends. In such a case, print data processing is performed while prioritizing PT. On the other hand, if the UI setting unit determines that PT is not prioritized (NO in step S801), the process proceeds to step S802.

If the printing user 105 is aware that the print setting information in the print ticket included in the print data 109 is the desired setting content, the printing user 105 selects prioritizing PT on the selection screen. In contrast, if the printing user 105 is not aware of the content of the print ticket included in the print data 109, the printing user 105 selects not prioritizing PT.

In step S802, the UI setting unit displays a screen for designating individual print setting contents, i.e., a print setting screen, as illustrated in FIG. 10C, and receives designation of the print setting content. According to the present exemplary embodiment, settings of “number of copies”, “one-sided/two-sided printing”, and “staple” are only displayed for ease of description.

In step S803, after the setting contents of each printing functions have been designated, the UI setting unit stores the setting contents, i.e., UI setting information, in the RAM 202, and the UI setting process ends.

The printing process using the direct print function of the printing apparatus 106 according to case 2 will be described below with reference to FIGS. 6 and 7.

In the direct print function, after the printing user 105 designates the print data 109 and instructs printing, the CPU 201 activates the print data processing unit. According to case 2, the settings are designated as described below via the print data designation screen and the print setting screen illustrated in FIG. 10C.

### (1) Prioritization of PT: No

(2) Number of copies: 3 copies
(3) One-sided/two-sided printing: Perform two-sided printing

### (4) Staple: No

Print data processing performed according to case 2 will be described below with reference to FIG. 6. In case 2, the printing user 105 is not aware whether the print setting information included in the print data 109 is the desired setting. The setting is thus specified not to prioritize PT. As a result, in step S501, the print data processing unit determines that PT is not prioritized (NO in step S501), and the process proceeds to step S504.

In step S504, the print data processing unit reads the print setting information of the printing apparatus 106, and stores the read print setting information in the print setting storing area 312 of the RAM 202 as the print setting information. The print setting information set via the print setting screen is thus read in step S504.

In step S505, the print data processing unit adds the read print setting information to the print setting information of the print ticket. The process then proceeds to step S503, and printing is performed.

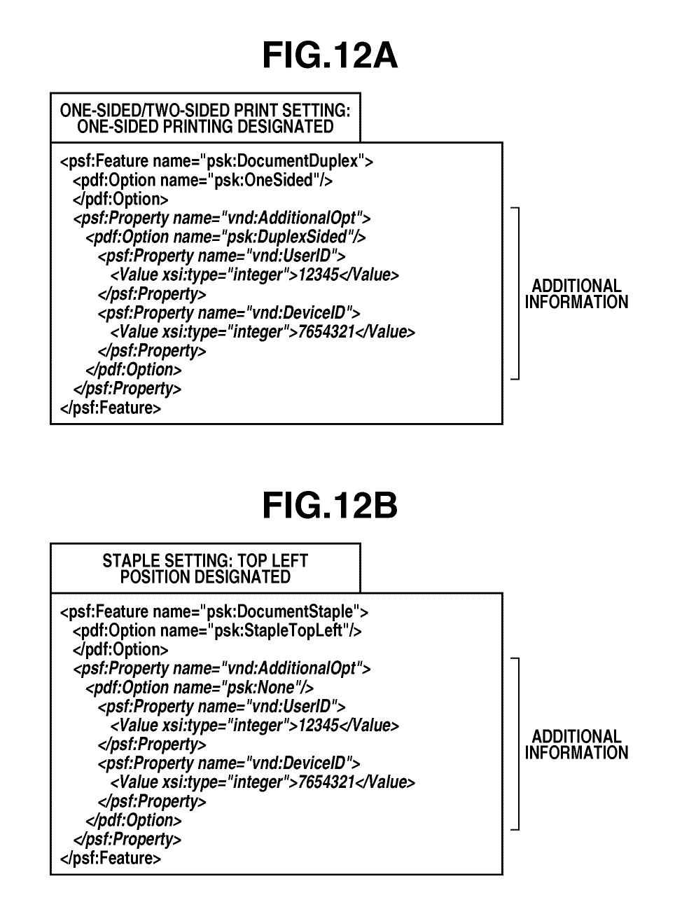

Further, when adding the read print setting information, the print data unit also adds the information acquired by an acquisition unit (not illustrated). The acquisition unit acquires user-specific information which is an example of user identification information for identifying the user. The acquisition unit also acquires printing apparatus-specific information which is an example of apparatus identification information for identifying the apparatus. For example, the acquisition unit reads user identification (ID) from authentication information managed in the printing apparatus 106, and sets the user ID as the user-specific information. Further, the acquisition unit reads device ID which is set when the printing apparatus is shipped from the factory, and sets the device ID as the printing apparatus-specific information. FIGS. 12A and 12B illustrate examples of the print ticket including the additional information.

FIG. 9B illustrates an example of the above-described process. Referring to FIG. 9B, the print data 109 is processed while prioritizing an input from the UI, i.e., PT is not prioritized. The printing user 105 can acquire the output result as instructed by the print setting information set by the printing user on the print setting screen.

Further, according to the above-described process, the print setting information set by the printing user 105 on the print setting screen is added to the print ticket in the print data 109, i.e., written in the print setting information, as illustrated in FIG. 9B.

If the print setting information is to be written in the print ticket, the printing apparatus adds to the print setting information to be written, the identification information for identifying the printing apparatus or the user, or both. More specifically, if the printing apparatus determines, when writing the print setting information, that the same printing apparatus or the user has previously added the print setting information, based on the identification information, the printing apparatus overwrites the previously added print setting information. Further, if the printing apparatus determines, when writing the print setting information, the same printing apparatus or the user has not previously added the print setting information, based on the identification information, the printing apparatus adds the print setting information.

<Case 3: Re-Printing Using the Direct Print Function>

In case 3, a process for re-printing the print data 109 including the additional information will be described below. More specifically, a case where the printing user 105 re-prints the print data 109 that has been once printed by performing the process according to case 2 will be described below.

The printing user 105 stores in the portable memory 104 the print data 109 that has been previously printed, and executes the direct print function similarly as in case 2 in which printing is performed using the direct print function. The printing user 105 again selects whether to prioritize PT on the screen as illustrated in FIG. 10D. Since the output result desired by the printing user 105 has been acquired by previously performing printing according to case 2, the printing user 105 selects prioritizing PT as illustrated in the screen of FIG. 10D according to case 3. Printing is then performed.

Print data processing performed according to case 3 will be described below with reference to FIG. 6. In step S501, the print data processing unit determines that PT is prioritized according to case 3 (YES in step S501). The process then proceeds to step S502, and the print setting process is performed.

The print setting process performed according to case 3 will be described below with reference to FIG. 7. In step S601, the print setting unit reads the print setting information from the print ticket. In step S602, the print setting unit determines whether the read print setting information is information corresponding to the function of the printing apparatus 106. According to case 3, the print setting unit determines that the print setting information is information corresponding to the function of the printing apparatus 106 (YES in step S602). The process thus proceeds to step S603. In step S603, the print setting unit determines whether the read print setting information is the prohibited print setting information in the printing apparatus 106. If the print setting unit determines that there is the prohibited print setting (YES in step S603), the process proceeds to step S608 and step S609. However, according to case 3, the print setting unit determines that there is no prohibited print setting (NO in step S603), and the process proceeds to step S605.

The subsequent processes will be described below by focusing on the print setting information of the staple function in the print data 109. According to case 3, the print setting information described in the print ticket indicates “staple top left position”. In step S602, the print setting unit thus determines that the print setting information is information corresponding to the function of the printing apparatus 106 (YES in step S602). The process thus proceeds to step S605.

In step S605, the print setting unit determines whether there is additional information to the print setting information. According to case 3, the additional information has been added when previously performing printing, so that the print setting unit determines that there is additional information to the print setting information (YES in step S605). The process then proceeds to step S606.

In step S606, the print setting unit determines whether the additional information has been added by the printing user 105. In such a case, the print setting unit compares the user-specific information in the authentication information and the user-specific information in the additional information. If the print setting unit determines that the additional information has been added by the printing user 105 (YES in step S606), the process proceeds to step S607. On the other hand, if the print setting unit determines that the additional information is not added by the printing user 105 (NO in step S606), the process proceeds to step S610.

According to case 3, re-printing is performed by the same user, so that the print setting unit determines in step S606 that the additional information has been added by the printing user 105 (YES in step S606), and the process proceeds to step S607.

In step S607, the print setting unit determines whether the additional information is with respect to the printing apparatus 106. In such a case, the print setting unit compares the printing apparatus-specific information of the printing apparatus 106 and the printing apparatus-specific information in the additional information. If the print setting unit determines that the additional information is with respect to the printing apparatus 106 (YES in step S607), the printing process ends. If the print setting unit determines that the additional information is not of the print apparatus 106 (NO in step S607), the process proceeds to step S610.

According to case 3, the same printing apparatus 106 performs re-printing, so that the print setting unit determines in step S607 that the additional information is with respect to the printing apparatus 106 (YES in step S607).

The print setting unit then stores the additional information as the print setting information in the print setting storing area 312, and the print setting process ends. The printing process (step S503 illustrated in FIG. 6) is thus performed. If the print setting unit determines that the additional information is added by another printing user (NO in step S606) or is with respect to another printing apparatus (NO in step S607), the process proceeds to step S610.

In step S610, the print setting unit reads the print setting information of the printing apparatus 106, stores the read information in the print setting storing area 312, and the print setting process ends. The printing process, i.e., step S503, is then performed. The above-described print setting information of the printing apparatus 106 becomes a default setting in the case where the user does not designate the setting content, unlike the UI setting information when using the direct print function. As a result, there is no addition to the print setting information.

The printing process, i.e., step S503, performed according to case 3 will be described below with reference to FIG. 8. If there is additional information, the additional information is stored as the print setting information in the print setting storing area 312 on the RAM 202 in the print setting process. According to case 3, the printing unit thus reads in step S701 the print setting information of the additional information as the print setting information. The processes of step S702 and subsequent steps are similar to those described above, thus, a further description will be omitted herein.

FIG. 9C illustrates an example of the above-described process. The print data 109 is processed while prioritizing PT, so that an output result as designated in the additional information in the print data 109 can be acquired.

If the print ticket is prioritized, and there is print setting information 901 with respect to the printing apparatus or designated by the user when printing the print data, determined based on the identification information, the printing apparatus prints using the print setting information 901 of the printing apparatus or the user. Further, if the print ticket is prioritized, and there is no print setting information 901 with respect to the printing apparatus or designated by the user when printing the print data, determined based on the identification information, the printing apparatus performs printing using initial print setting information 902 included in the print data 109.

As described above, according to the present exemplary embodiment, the result of printing performed by the printing user 105, i.e., the setting content, is previously stored as the additional information. As a result, the output result desired by the printing user 105 can be acquired without re-designating the setting contents.

<Case 4: Transmission of the Print Data>

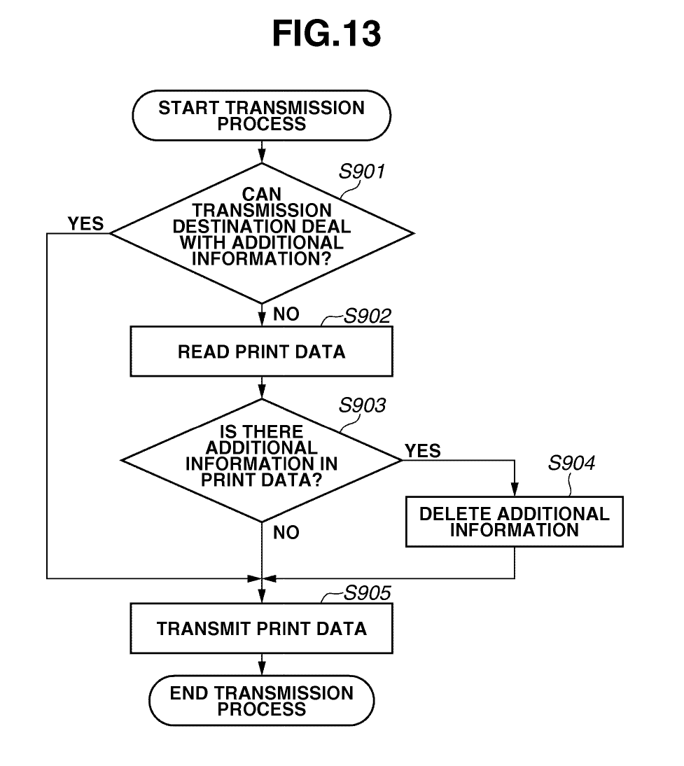

In case 4, a process in which the print data 109 is transmitted from the printing apparatus 106 to the printing apparatus 108 i.e., another printing apparatus, will be described below. The printing user 105 employs a SEND function of the printing apparatus 106, i.e., a data transmission function, to transmit the print data 109 to the printing apparatus 108. The process will be described below with reference to FIG. 13.

According to case 4, the printing user 105 designates as the print data to be transmitted, the print data 109 stored in the portable memory 104 connected to the printing apparatus 106. According to the present example, the processes performed up to the data selection process can be performed employing the above-described processes as appropriate, thus, a detailed description is omitted herein.

FIG. 13 is a flowchart illustrating a process performed according to the transmission program 304. A transmission unit is realized by the CPU 201 in the printing apparatus 106 executing the transmission program 304.

In step S901, the transmission unit determines whether a transmission destination can handle the additional information of the print data 109 (i.e., the additional information). The transmission unit performs the determination based on whether the printing apparatuses are of the same model or of the same manufacturer. According to case 4, the transmission unit performs the determination based on the information indicating whether the printing apparatuses are of the same model.

If the transmission unit determines that the transmission destination can handle the additional information of the print data 109 (YES in step S901), the process proceeds to step S905. On the other hand, if the transmission unit determines that the transmission destination cannot handle the additional information of the print data 109 (NO in step S901), the process proceeds to step S902. According to case 4, the printing apparatus 106 and the printing apparatus 108 are of different models. As a result, the transmission unit determines that the printing apparatus 108 cannot handle the additional information of the print data 109, and the process proceeds to step S902.

In step S902, the transmission unit reads the print data 109. In step S903, the transmission unit determines whether the additional information is included in the print data 109. If the transmission unit determines that there is no additional information (NO in step S903), the process proceeds to step S905. If the transmission unit determines that there is additional information (YES in step S903), the process proceeds to step S904. According to case 4, the additional information is included in the print data 109, so that the transmission unit performs the process of step S904.

In step S904, the transmission unit deletes the additional information from the print data 109. As a result, the additional information is deleted from the print data. In step S905, the transmission unit transmits the print data 109 to the printing apparatus 108.

As described above, according to case 4, the additional information in the print data 109 is deleted, and the print data 109 is then transmitted to the printing apparatus as illustrated in FIG. 9D. Since unnecessary additional information is deleted, an excessive increase in the size of the print data can be prevented. The additional information is simply an addition of information, so that the additional information is ignored even when it is transmitted to a printing apparatus that cannot deal with such additional information.

According to the present exemplary embodiment, a case where there is one type of additional information is described as an example. In another exemplary embodiment, there may be a plurality of additional information, and in such a case, an upper limit of a number of additional information is determined, and the additional information is deleted from the older information.

The present exemplary embodiment is not limited to the above-described configuration. For example, it is not necessary to implement both the process performed in step S606 and the process performed in step S607 illustrated in FIG. 7, wherein only one of the processes can be implemented. Moreover, the process of step S607 may be performed previous to the process of step S602. In such a case, if the print setting unit determines that the additional information is with respect to the print apparatus 106, the process of step S602 is not performed.

According to the above-described exemplary embodiment, the print setting content of the print data that has been previously printed is added as the additional information to the print data. As a result, it becomes unnecessary to re-designate the setting content in the subsequent printing processes, and the printing result as intended by the user and appropriate for the printing apparatus can be acquired.

Further, according to the above-described exemplary embodiment, user information and printing apparatus information are included in the print setting information as the additional information. The printing result appropriate for each user and each printing apparatus can thus be acquired even when the same print data is to be printed.

Aspects of the present invention can also be realized by supplying software (program code) for realizing the functions of the above-described exemplary embodiment to a system or an apparatus via a network or various computer-readable storage media, and the system or a computer (i.e., a CPU or a microprocessor unit (MPU)) of the apparatus reading and executing the program code.

According to the above-described exemplary embodiment, printing employing the direct print function can be appropriately performed.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-271737 filed Dec. 6, 2010, which is hereby incorporated by reference herein in its entirety.

What is claimed is:

1. A printing apparatus comprising:
an interface unit configured to connect a portable memory storing print data including a print ticket; and
a processing unit configured to set print setting information,
wherein the processing unit is further configured to, if the print ticket is prioritized when printing the print data, print the print data based on print setting information included in the print ticket, and if the print ticket is not prioritized when printing the print data, add the print setting information to the print data and print the print data based on the print setting information.

2. The printing apparatus according to claim 1, wherein the processing unit prints, if the print ticket is prioritized when printing the print data, the print data based on print setting information to be used in the printing apparatus included in the print ticket.

3. The printing apparatus according to claim 1, wherein the print setting information includes specific information for specifying a printing apparatus, and
wherein the processing unit specifies, if the print ticket is prioritized when printing the print data, print setting information to be used in the printing apparatus based on the specific information from print setting information included in the print ticket, and prints the print data based on the specified print setting information to be used in the printing apparatus.

4. The printing apparatus according to claim 1, wherein the processing unit prints, if the print ticket is prioritized when printing the print data, the print data based on print setting information to be used by a printing user included in the print ticket.

5. The printing apparatus according to claim 1, wherein the print setting information includes specific information for specifying a user, and
wherein the processing unit specifies, if the print ticket is prioritized when printing the print data, print setting information to be used by a printing user based on the specific information from print setting information included in the print ticket, and prints the print data based on the specified print setting information to be used by the printing user.

6. An image forming apparatus comprising:
an operation unit configured to receive a user operation;
a processing unit configured to add, if the operation unit receives a user operation instructing printing of print data by designating a print setting content in the image forming apparatus, setting information indicating the print setting content designated by the user operation, to the print data; and
a recording unit configured to, if the processing unit adds setting information, print the print data according to the setting information, and to print, if the operation unit receives a user operation instructing printing of the print data, the print data according to the setting information added to the print data.

7. The image forming apparatus according to claim 6, wherein the recording unit determines, if the operation unit receives a user operation instructing printing of print data, whether the print data includes setting information corresponding to the image forming apparatus, and if it is determined that the print data includes the setting information corresponding to the image forming apparatus, prints the print data according to the setting information.

8. The image forming apparatus according to claim 6, wherein the recording unit determines, if the operation unit receives a user operation instructing printing of print data, whether the print data includes setting information not permitted in the image forming apparatus, and rewrites, if it is determined that the print data includes the setting information not permitted in the image forming apparatus, the setting information of the print data to a previously specified setting information, and prints the print data according to the setting information.

9. The image forming apparatus according to claim 6, wherein the processing unit further adds, when adding setting information, user identification information for identifying a user who has performed the user operation of the setting information, and
wherein the recording unit determines, if the operation unit receives a user operation instructing printing of print data and user identification information is added to the print data, whether the user identification information is information indicating a user who has performed a user operation for instructing printing of the print data, and prints, if it is determined that the user identification information is the information indicating the user, the print data according to the setting information added to the print data.

10. The image forming apparatus according to claim 6, wherein the processing unit further adds, when adding setting information, apparatus identification information for identifying the image forming apparatus, and
wherein the recording unit determines, if the operation unit receives a user operation instructing printing of print data and apparatus identification information is added to the print data, whether the apparatus identification information is information indicating the image forming apparatus, and if it is determined that the apparatus identification information is the information indicating the image forming apparatus, prints the print data according to the setting information added to the print data.

11. The image forming apparatus according to claim 6, wherein the processing unit is further configured to determine, when the operation unit receives a user operation instructing transmission of print data to a different image forming apparatus, whether setting information added by the processing unit can be processed by the different image forming apparatus, and to transmit, if it is determined that the different image forming apparatus can process the setting information, the print data to the different image forming apparatus, and to transmit, if it is determined that the different image forming apparatus cannot process the setting information, print data obtained by deleting the setting information from the print data, to the different image forming apparatus.

12. A printing method comprising:
obtaining print data including a print ticket;
setting print setting information; and
printing, if the print ticket is prioritized when printing the print data, the print data based on print setting information included in the print ticket, and if the print ticket is not prioritized when printing the print data, adding to the print data the set print setting information and printing the print data based on the set print setting information.

13. A computer-readable storage medium storing computer-executable process steps for causing a computer to execute the method of claim 12.

14. A printing method for an image forming apparatus, the printing method comprising:
receiving a user operation;
adding, if a user operation instructing printing of print data by designating a print setting content in the image forming apparatus is received, setting information indicating the print setting content designated by the user operation, to the print data; and
printing, if the setting information is added, the print data according to the setting information, and printing, if a user operation instructing printing of the print data is received, the print data according to the setting information added to the print data.

15. A computer-readable storage medium storing computer-executable process steps for causing a computer to execute the method of claim 14.
